(19) United States
(12) Patent Application Publication
(10) Pub. No.: US 2013/0006581 A1
(43) Pub. Date: Jan. 3, 2013

(54) COMBUSTOR HEALTH AND PERFORMANCE MONITORING SYSTEM FOR GAS TURBINES USING COMBUSTION DYNAMICS

(75) Inventors: Kapil Kumar Singh, Rexford, NY (US); Fei Han, Clifton Park, NY (US); Deepali Nitin Bhate, Bangalore (IN); Shivakumar Srinivasan, Greer, SC (US); Preetham Balasubramanyam, Schenectady, NY (US); Qingguo Zhang, Schenectady, NY (US); KrishnaKumar Venkatesan, Clifton Park, NY (US); Christian Lee Vandervort, Voorheesville, NY (US)

(73) Assignee: GENERAL ELECTRIC COMPANY, Schenectady, NY (US)

(21) Appl. No.: 13/173,139

(22) Filed: Jun. 30, 2011

(51) Int. Cl. G06F 15/00

(52) U.S. Cl. 702/185; 702/183

(57) ABSTRACT

A system and method each utilize combustion dynamics data to monitor and assess gas turbine combustor health and performance. The system and method each employ a physics-based model to differentiate changes in the spectral features attributable to variations in the operating conditions from differences caused from changes in the hardware.

### BACKGROUND

This invention relates generally to gas turbine engines, and more particularly, to a system and method for monitoring the health and performance of a gas turbine engine using combustion dynamics data observed during its operation.

Gas turbine engines generally include, in serial flow arrangement, a high-pressure compressor for compressing air flowing through the engine, a combustor in which fuel is mixed with the compressed air and ignited to form a high temperature gas stream, and a high-pressure turbine. The high-pressure compressor, combustor and high-pressure turbine are sometime collectively referred to as the core engine. At least some known gas turbine engines also include a low-pressure compressor, or booster, for supplying compressed air to the high-pressure compressor.

Gas turbine engines are used in many applications, including aircraft, power generation, and marine applications. The desired engine operating characteristics vary, of course, from application to application.

Gas turbine operators continuously seek to assess the current state and remaining life of gas turbines. Combustors in the gas turbines, due to their lower design life, tend to be on the critical path in determining shutdown times required for repair or causing unscheduled shutdowns due to failures.

In view of the foregoing, there is a need for a system and method for off-line as well as on-line monitoring the health and performance of gas turbine combustors and to assist operators to either avoid unscheduled shutdowns or to help plan shutdowns of gas turbine engines around peak requirements.

### BRIEF DESCRIPTION

According to one embodiment, a gas turbine combustor health and performance monitoring system (CHPMS) comprises:

a real-time monitoring and analysis data processing module (RMAM) in electrical communication with and configured to receive real-time gas turbine operating condition data and real-time combustion dynamics data from one or more corresponding gas turbine controllers and corresponding sensors and on-site monitoring systems and corresponding sensors;

a spectral and wavelet analysis (SWA) data processing system in electrical communication with and configured to receive time domain combustion dynamics data from the RMAM and to evaluate the time domain combustion dynamics data to identify high-amplitude signal characteristics and corresponding patterns and trends, and further configured to convert the combustion dynamics data to frequency domain data;

an early detection data processing system (EDS) in electrical communication with and configured to receive time domain combustion dynamics data from the RMAM and to evaluate the combustion dynamics data to identify low-amplitude patterns and trends having a potential to grow in the near future;

a physics based prediction tools (PBPT) data processing system in communication with and configured to receive real-time gas turbine operating condition data from the RMAM and to evaluate the operating condition data and predict combustion dynamics therefrom, and further configured to compare the predicted combustion dynamics against the real-time combustion dynamics data generated by the SWA data processing system and the EDS to identify features and amplitudes which cannot be explained by variations caused only by operating conditions;

a historical data and failure analysis database (HDFAD) data processing system;

a machine history analysis (MHA) data processing system in electrical communication with the RMAM, PBPAT and HDFAD, wherein the MHA is configured to store the data generated via the PBPT, and further configured to evaluate the stored PBPT data to identify patterns and trends and to compare the patterns and trends identified from the stored PBPT data to historical data stored in the HDFAD data processing system to generate current combustor condition data and to identify and communicate the existence of any trend precedents to the PBPT such that the PBPT functions to identify potential causes of new trends and to provide remaining life assessment data based on the historical trending identified by the MHA; and

a self-assessment and improvement (SAIM) data processing system in electrical communication with the RMAM, wherein the real-time monitoring and analysis data processing module continuously compares the life assessment data and the resultant trend in predicted dynamics to real-time data and trends to identify differences that are communicated to the SAIM data processing system such that the SAIM data processing system analyzes the differences and generates resultant combustor health, performance and life assessment data that is communicated by the RMAM to corresponding gas turbine monitors and controllers.

According to another embodiment, a gas turbine combustor health and performance monitoring system (CHPMS) comprises:

a real-time monitoring and analysis data processing module (RMAM) in electrical communication with and configured to receive real-time combustion dynamics data from at least one of a corresponding gas turbine controller and a corresponding on-site monitoring system;

a physics based prediction tools (PBPT) data processing system in communication with and configured to receive the real-time gas turbine combustion dynamics data from the RMAM and to evaluate the combustion dynamics data and generate spectral feature trend data therefrom;

a historical field data analysis data processing module in communication with the RMAM and configured to generate observed behavior combustor data based on historical field combustor data, wherein the RMAM is further configured to compare the spectral feature trend data to the observed behavior combustor data to determine whether the combustor health is good or is deteriorating and to generate decision data therefrom; and

an operator monitoring system in communication with the RMAM and configured to receive and display the decision data generated by the RMAM to a system operator.

According to yet another embodiment, a method of determining gas turbine combustor health comprises:

generating real-time gas turbine combustion dynamics data via one or more sensors disposed at predetermined locations in a combustor;

evaluating the combustion dynamics data and generating spectral feature trend data therefrom via a physics based prediction tools data processing system;

generating observed behavior combustor data based on historical field combustor data via a historical field data analysis data processing module;

comparing the spectral feature trend data to the observed behavior combustor data via a real-time monitoring and analysis data processing module to determine whether the combustor health is good or is deteriorating and generating decision data therefrom; and

communicating the decision data to a monitoring system display.

According to still another embodiment, a method of determining gas turbine combustor health comprises:

evaluating time domain combustion dynamics data generated by one or more controllers, sensors and monitoring systems via a spectral and wavelet analysis data processing system (SWA) to identify gas turbine combustor high-amplitude signal characteristics and corresponding patterns and trends, and converting the combustion dynamics data to frequency domain data via the SWA;

evaluating the combustion dynamics data via an early detection data processing system (EDS) to identify low-amplitude patterns and trends having a potential to grow in the near future;

evaluating combustor operating condition data via a physics based prediction tools data processing system (PBPT) and predicting combustion dynamics therefrom, and comparing the predicted combustion dynamics against the real-time combustion dynamics data generated by the SWA and the EDS to identify features and amplitudes which cannot be explained by variations caused only by operating conditions;

storing and evaluating the data generated via the PBPT to identify patterns and trends, and comparing the patterns and trends to historical data stored in a historical data failure analysis database to generate current combustor condition data, and identifying and communicating the existence of any trend precedents to the PBPT such that the PBPT functions to identify potential causes of new trends and to provide remaining life assessment data based on the historical trending identified by the MHA;

comparing the life assessment data and the resultant trend in predicted dynamics to real-time data and trends via a real-time monitoring and analysis data processing module (RMAM) to identify differences that are communicated to a self-assessment and improvement data processing system (SAIM) such that the SAIM data processing system analyzes the differences and generates resultant combustor health, performance and life assessment data; and

communicating the resultant combustor health, performance and life assessment data via the RMAM to one or more corresponding gas turbine monitors and controllers.

### DRAWINGS

These and other features, aspects, and advantages of the present invention will become better understood when the following detailed description is read with reference to the accompanying drawing, wherein:

FIG. 1 is a block diagram illustrating a combustor health and performance monitoring system (CHPMS) according to one embodiment;

FIG. 2 is a graph illustrating representative dynamics spectra highlighting various peaks and potential distress candidates for a gas turbine combustor according to one embodiment;

FIG. 3 is a diagram illustrating placement of three pressure sensors (PCBs) strategically located in axial and transverse directions on a combustor liner; and

FIG. 4 is a flow chart illustrating a method of combustor health monitoring according to one embodiment.

While the above-identified drawing figures set forth particular embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION

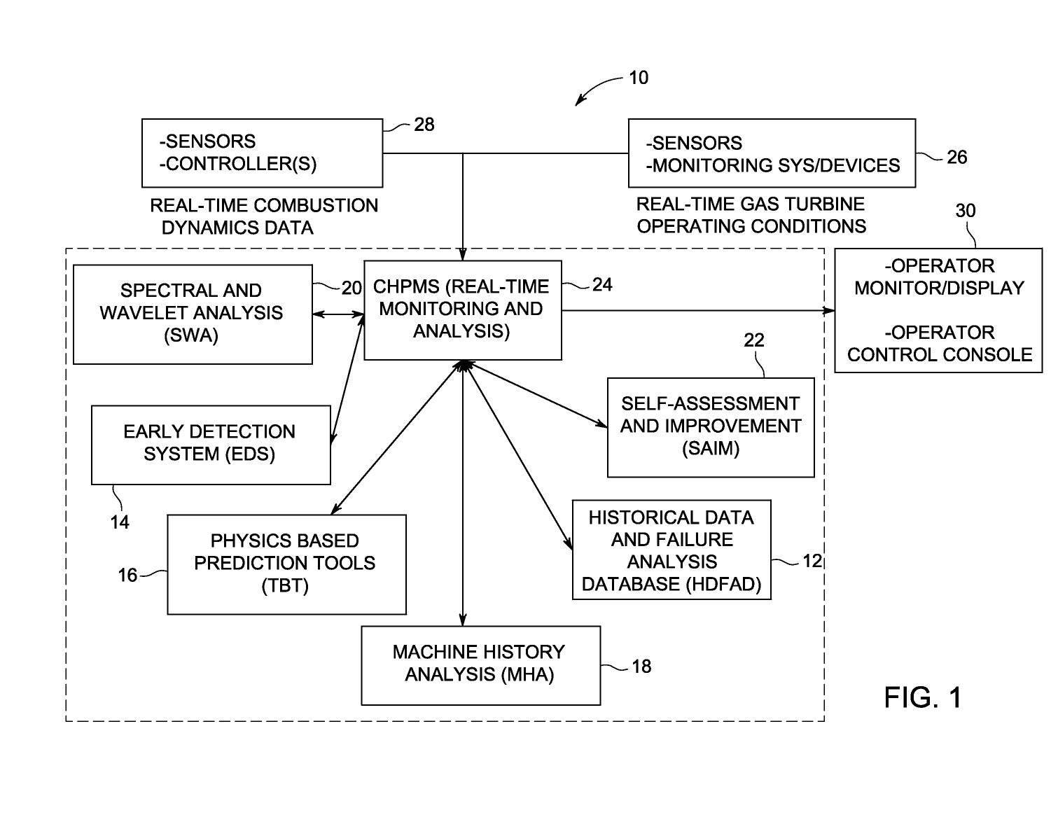

FIG. 1 is a block diagram illustrating a combustor health and performance monitoring data processing system (CHPMS) 10 according to one embodiment. The embodied CHPMS data processing system 10 comprises six data processing subsystems that include a Historical Data and Failure Analysis Database (HDFAD) data processing system 12, an Early Detection data processing system (EDS) 14, a Physics Based Prediction Tools (PBT) data processing system 16, a Machine History Analysis (MHA) data processing system 18, a Spectral and Wavelet Analysis (SWA) data processing system 20, and a Self Assessment and Improvement data processing Module (SAIM) 22. Each subsystem may comprise at least one data processing device such as, without limitation, a CPU, microcomputer, microcontroller or DSP and corresponding data storage devices such as, for example, RAM, ROM, EEPROM, and HD/SSHD devices and associated interface devices, e.g. A/D and D/A devices, timing clocks, latches, counters, etc., allowing communication among the various data processing subsystems.

The gas turbine combustor health and performance monitoring system (CHPMS) 10 further comprises a real-time monitoring and analysis data processing module (RMAM) 24 that also may comprise a data processor such as, without limitation, a CPU or DSP and corresponding memory devices such as, for example, RAM, ROM, EEPROM, and HD/SSHD devices and associated interface devices, e.g. A/D and D/A devices, etc., allowing communication between the RMAM 24 and the associated subsystems. According to one embodiment, RMAM 24 is configured to receive real-time gas turbine operating condition data 26 and real-time combustion dynamics data from one or more corresponding gas turbine controllers and/or sensors 28 and/or on-site monitoring systems and/or sensors 26.

According to one embodiment, the spectral and wavelet analysis (SWA) data processing system 20 is configured to receive time domain combustion dynamics data from the real-time monitoring and analysis data processing module 24 and to evaluate the time domain combustion dynamics data to identify high-amplitude signal characteristics and corresponding patterns and trends. According to one aspect, the SWA data processing system 20 is further configured to convert the combustion dynamics data to frequency domain data.

The early detection data processing system (EDS) 14 according to one embodiment is configured to receive time domain combustion dynamics data from the real-time monitoring and analysis data processing module 24 and to evaluate the combustion dynamics data to identify low-amplitude patterns and trends having a potential to grow in the near future. The EDS 14 may, for example, employ singular spectral analysis, time series analysis, and PDF methods such as Monte-Carlo analysis techniques to evaluate the combustion dynamics data.

The physics based prediction tools (PBPT) data processing system 16 according to one embodiment is configured to receive real-time gas turbine operating condition data from the real-time monitoring and analysis data processing module 24 and to evaluate the operating condition data and predict combustion dynamics therefrom. According to one aspect, PBPT data processing system 16 is further configured to compare the predicted combustion dynamics against the real-time combustion dynamics data generated via the SWA data processing system 20 and the EDS 14 to identify features and amplitudes which cannot be explained by variations caused by operating conditions alone.

The machine history analysis (MHA) data processing system 18 according to one embodiment is configured to store the data generated via the PBPT data processing system 16, and further configured to evaluate the stored PBPT data processing system generated data to identify patterns and trends and to compare the patterns and trends identified from the stored PBPT data processing system generated data to historical data that is stored in the historical data and failure analysis database (HDFAD) data processing system 12 to generate current combustor condition data and to identify and communicate the existence of any trend precedents to the PBPT data processing system 16 allowing the PBPT data processing system 16 to identify potential causes of new trends and to provide a remaining life assessment data based on the historical trending identified by the MHA data processing system 18.

The real-time monitoring and analysis data processing module 24 according to one embodiment continuously compares the life assessment data and the resultant trend in predicted dynamics to real-time data and trends to identify differences that are communicated to the SAIM data processing system 20 allowing the SAIM data processing system 20 to analyze the differences and generate combustor health, performance and life assessment data therefrom that is communicated via the real-time monitoring and analysis data processing module 24 to corresponding gas turbine monitors and controllers 26, 28.

It can be appreciated that the CHPMS 10 leverages active research and development efforts by OEMs to predict and analyze combustion dynamics during the design stage of development, and advantageously uses these prediction tools in a combustor health and performance monitoring system 10 according to the principles described herein. The embodiments described herein are not so limited however, and it can also be appreciated that one or more additional subsystems can be included or even removed as desired or necessary to accommodate a particular application. Further, additional capabilities may be added or removed from any one or more subsystem or the CHPMS 10 itself as desired or necessary to accommodate a particular application of the principles described herein.

The embodiments described herein are best understood with an understanding that premixed gas turbines have faced combustion dynamics issues since their advent in response to increasingly lower emissions. The premixed flame is more susceptible to perturbations in fuel-air ratio and established a feedback cycle with the natural modes of the combustor, driving very high pressure pulsations known as combustion dynamics or combustion instabilities. The frequency and amplitude of combustion dynamics depend upon operating conditions, combustor geometry, combustor damping, and combustor structural health. The spectra of the combustion dynamics signal from gas turbine combustors exemplifies several features including multiple peaks corresponding to various axial modes, harmonics/overtones, screech modes corresponding to transverse and radial modes and their harmonics. Trends in relative strength of these features and their presence/absence can be used to assess health of the combustor.

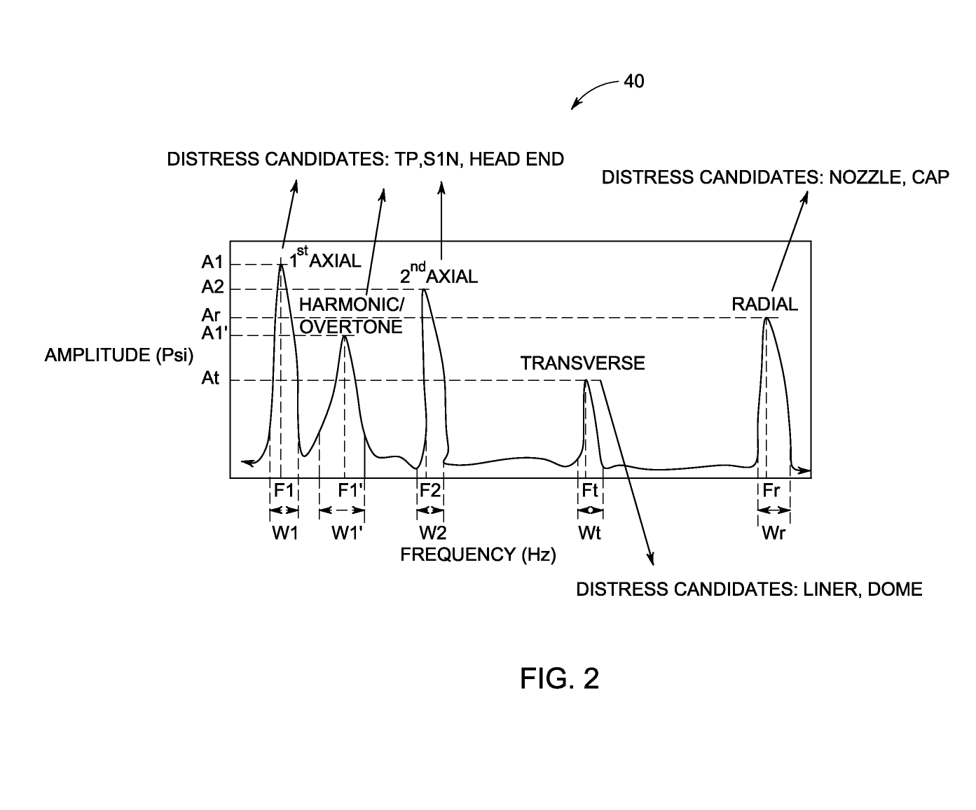

More specifically, a physics-based model can be used to differentiate the changes in the spectral features attributable to variations in the operating conditions from the differences caused from changes in the corresponding hardware. Once identified, these trends in the spectra can be correlated with the observed failures in the field. Further, a phased-array of audio sensors, e.g. microphones, PCBs, strategically located inside a combustor can substantiate and provide the capability to differentiate spectral variation trends due to hardware condition changes. Keeping the foregoing details in mind, one embodiment of a spectral health monitoring approach is now described with reference to FIGS. 2-4.

FIG. 2 is a graph illustrating representative dynamics spectra 40 highlighting various peaks and potential distress candidates for a gas turbine combustor according to one embodiment. Combustion dynamics spectral features can be employed to assess combustor hardware conditions, as stated herein. The spectra of combustion dynamics inside a gas turbine combustor typically contain features pertaining to axial, transverse, and radial modes. The relative strengths of these features and the associated trends can be used to assess the condition of combustor hardware. With continued reference to FIG. 2, representative spectrum 40 highlights various peaks associated with natural modes of a combustor according to one embodiment. The frequencies and amplitudes of first and second axial modes are represented as F1 and A1 and F2 and A2 respectively. The widths of the corresponding peaks are denoted by W1 and W2 in FIG. 2. The first harmonic/overtone of the first axial mode occurs at frequency F1′, has an amplitude A1′ and a peak width W1′. Similarly, the frequency, amplitude and peak widths for transverse and radial modes are Ft, At and Wt and Fr, Ar and Wr respectively.

The frequency and amplitudes of various modes and their harmonics depend on changes in operating conditions as well as combustor hardware changes, as stated herein. A physics-based prediction tool is advantageous as a tool to distinguish these two types of changes and to properly identify trends in features attributable to hardware changes. These trends can be correlated with the observed behavior using analysis of field data as described according to particular embodiments described herein.

The amplitude ‘A’ drops and the width ‘W’ of the peak increases with aging of combustor hardware since the tolerances get worse due to wear and tear of the combustor hardware. Further, the frequency ‘F’ shifts with continued operation. Thus, the ratio of original amplitude to a later amplitude (A_initial/A_Current) can be used in conjunction with (W_initial/W_current) and the shift in frequency (F_initial/F_current) to develop an algorithm to correlate these ratios with the current condition of combustor hardware. Further, the presence and absence of a particular peak during identical operating conditions can be correlated to changes in combustor hardware.

FIG. 2 also highlights various distress candidates associated with different modes according to one embodiment, wherein axial modes are related to TP, S1N and Head-End, and transverse and radial modes are associated with liner and dome, and nozzle and cap respectively. It can be appreciated that additional combustion dynamics sensors can be strategically located with respect to a combustor to substantiate the observed behavior from the spectral trending.

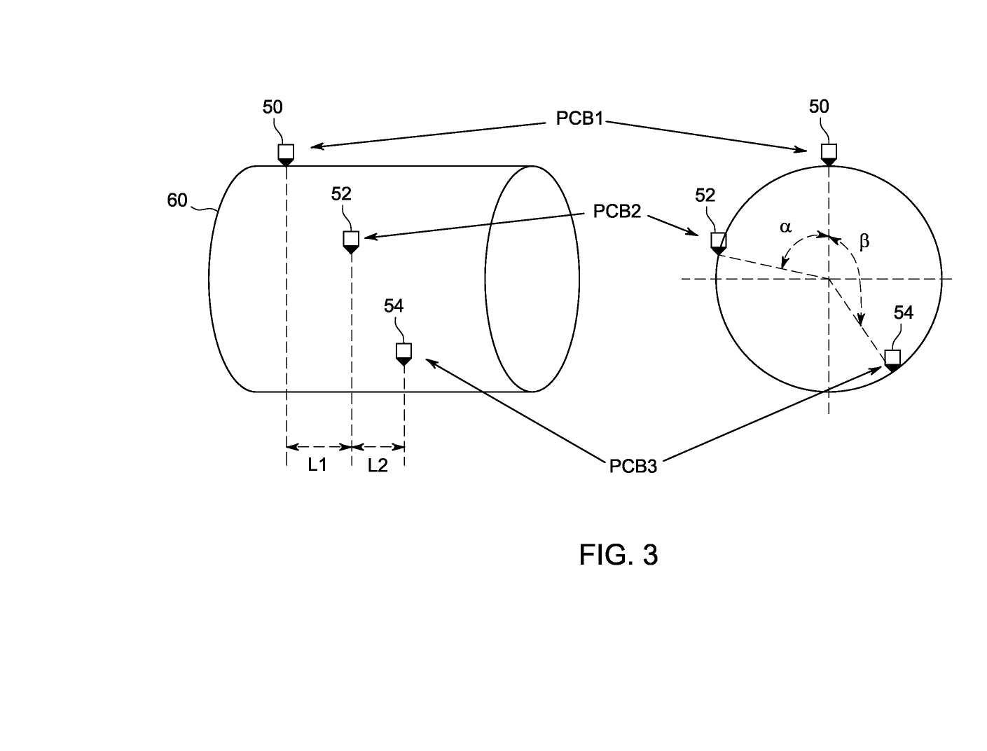

FIG. 3 is a diagram illustrating placement of three pressure sensors (PCBs) 50, 52, 54 strategically located in axial and transverse directions on a combustor liner 60. These pressure sensors 50, 52 and 54 are suitable for generating the spectra of a combustion dynamics signal from a gas turbine combustor according to one embodiment. The separation lengths L1 and L2 and separation angles α and β according to one embodiment are chosen with respect to various observed frequencies F1, F2, Ft and Fr in the spectra 40. According to one embodiment, the PCBs 50, 52, 54 can be phased-arrays in order to further refine the analysis.

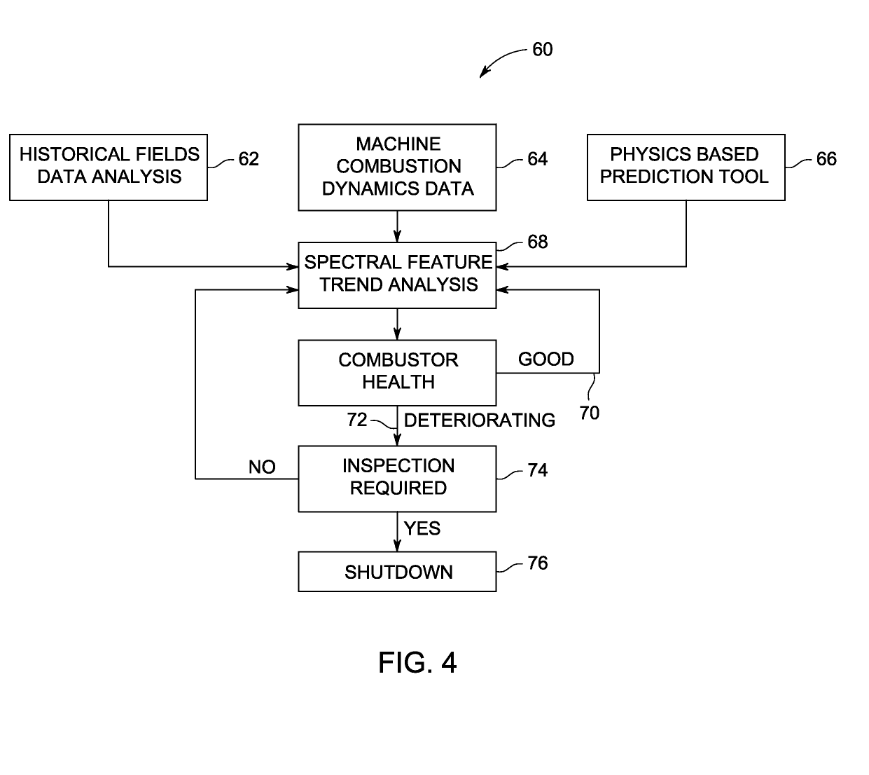

FIG. 4 is a flow chart illustrating a method of spectral health monitoring 60 according to one embodiment. The method of spectral health monitoring 60 relies on information provided by historical field data analysis 62, machine combustion dynamics data 64, and information provided by physics-based prediction tools 66. Historical field data, machine combustion dynamics data and physics-based data are communicated to the real-time monitoring and analysis data processing system 24 depicted in FIG. 1 according to one embodiment. The real-time monitoring and analysis data processing system 24 operates in response to a desired algorithmic software that is embedded within the real-time monitoring and analysis data processing system 24 to implement a spectral feature trend analysis 68 such as that described herein with reference to FIGS. 2 and 3. A decision based upon the resultant spectral feature trend analysis is used to determine if the state of combustor health is good 70 or whether the state of combustor health is deteriorating 72. The spectral feature trend analysis continues in perpetuity if the state of combustor health is good. Otherwise, if the state of combustor health is deteriorating, a decision based upon the resultant spectral feature trend analysis is made as to whether an inspection is required 74 or as to whether the combustor should be scheduled for a shut down 76 to implement repair or maintenance on the combustor.

The embodiments described herein advantageously assist gas turbine users in avoiding costly hardware damage and downtime caused by unscheduled shutdowns. Further, the principles described herein assist gas turbine users in scheduling shutdowns around peak demand as well as evaluating the possibility of extending combustor life beyond its design life. The embodiments described herein further employ ubiquitous combustion dynamics data to monitor combustor hardware health, thus allowing a broad range of applications.

Those skilled in the art will readily appreciate there are numerous ways to analyze combustion dynamics data as well as to develop a physics model to predict dynamics frequency and amplitudes. Any such analysis and development techniques can be applied using the principles described herein to develop systems and methods of combustor health assessment using spectral analysis of combustion dynamics data so long as those techniques employ the spectral features of the dynamics data and their associated trends with hardware changes to assess the health of the combustors.

While the invention has been described in terms of various specific embodiments, those skilled in the art will recognize that the invention can be practiced with modification within the spirit and scope of the claims.

What is claimed is:

1. A gas turbine combustor health and performance monitoring system (CHPMS) comprising:
a real-time monitoring and analysis data processing module (RMAM) in electrical communication with and configured to receive real-time gas turbine operating condition data and real-time combustion dynamics data from one or more corresponding gas turbine controllers and corresponding sensors and on-site monitoring systems and corresponding sensors;
a spectral and wavelet analysis (SWA) data processing system in electrical communication with and configured to receive time domain combustion dynamics data from the RMAM and to evaluate the time domain combustion dynamics data to identify high-amplitude signal characteristics and corresponding patterns and trends, and further configured to convert the combustion dynamics data to frequency domain data;
an early detection data processing system (EDS) in electrical communication with and configured to receive time domain combustion dynamics data from the RMAM and to evaluate the combustion dynamics data to identify low-amplitude patterns and trends having a potential to grow in the near future;
a physics based prediction tools (PBPT) data processing system in communication with and configured to receive real-time gas turbine operating condition data from the RMAM and to evaluate the operating condition data and predict combustion dynamics therefrom, and further configured to compare the predicted combustion dynamics against the real-time combustion dynamics data generated by the SWA data processing system and the EDS to identify features and amplitudes which cannot be explained by variations caused only by operating conditions;
a historical data and failure analysis database (HDFAD) data processing system;
a machine history analysis (MHA) data processing system in electrical communication with the RMAM, PBPAT and HDFAD, wherein the MHA is configured to store the data generated via the PBPT, and further configured to evaluate the stored PBPT data to identify patterns and trends and to compare the patterns and trends identified from the stored PBPT data to historical data stored in the HDFAD data processing system to generate current combustor condition data and to identify and communicate the existence of any trend precedents to the PBPT such that the PBPT functions to identify potential causes of new trends and to provide remaining life assessment data based on the historical trending identified by the MHA; and
a self-assessment and improvement (SAIM) data processing system in electrical communication with the RMAM, wherein the real-time monitoring and analysis data processing module continuously compares the life assessment data and the resultant trend in predicted dynamics to real-time data and trends to identify differences that are communicated to the SAIM data processing system such that the SAIM data processing system analyzes the differences and generates resultant combustor health, performance and life assessment data that is communicated by the RMAM to corresponding gas turbine monitors and controllers.

2. The CHPMS according to claim 1, further comprising a monitoring system and one or more corresponding sensing devices in communication with the CHPMS and configured to acquire the real-time gas turbine operating condition data.

3. The CHPMS according to claim 1, further comprising a gas turbine controller and one or more corresponding sensing devices in communication with the CHPMS and configured to acquire the real-time combustion dynamics data.

4. The CHPMS according to claim 1, wherein the gas turbine comprises a premixed gas turbine.

5. A gas turbine combustor health and performance monitoring system (CHPMS) comprising:
a real-time monitoring and analysis data processing module (RMAM) in electrical communication with and configured to receive real-time combustion dynamics data from at least one of a corresponding gas turbine controller and a corresponding on-site monitoring system;
a physics based prediction tools (PBPT) data processing system in communication with and configured to receive the real-time gas turbine combustion dynamics data from the RMAM and to evaluate the combustion dynamics data and generate spectral feature trend data therefrom;
a historical field data analysis data processing module in communication with the RMAM and configured to generate observed behavior combustor data based on historical field combustor data, wherein the RMAM is further configured to compare the spectral feature trend data to the observed behavior combustor data to determine whether the combustor health is good or is deteriorating and to generate decision data therefrom; and
an operator monitoring system in communication with the RMAM and configured to receive and display the decision data generated by the RMAM to a system operator.

6. The CHPMS according to claim 5, wherein the spectral feature trend data comprises one or more of axial mode data, transverse mode data, and radial mode data.

7. The CHPMS according to claim 5, wherein the spectral feature trend data comprises one or more of frequency, amplitude, and peak width data.

8. The CHPMS according to claim 5, wherein the gas turbine combustor comprises a premixed gas turbine combustor.

9. A method of determining gas turbine combustor health, the method comprising:
acquiring real-time gas turbine combustion dynamics data via one or more sensors disposed at predetermined locations in a combustor;
evaluating the combustion dynamics data and generating spectral feature trend data therefrom via a physics based prediction tools data processing system;
generating observed behavior combustor data based on historical field combustor data via a historical field data analysis data processing module;
comparing the spectral feature trend data to the observed behavior combustor data via a real-time monitoring and analysis data processing module to determine whether the combustor health is good or is deteriorating and generating decision data therefrom; and
communicating the decision data to a monitoring system display.

10. The method according to claim 9, further comprising disposing the sensors in predetermined axial and transverse directions on a corresponding combustor liner.

11. The method according to claim 10, wherein disposing the sensors in predetermined axial and transverse directions on a corresponding combustor liner comprises separating the sensors axially from one another by predetermined lengths.

12. The method according to claim 10, wherein disposing the sensors in predetermined axial and transverse directions on a corresponding combustor liner comprises separating the sensors radially from one another by predetermined separation angles.

13. The method according to claim 9, wherein generating real-time gas turbine combustion dynamics data comprises generating one or more of axial mode frequency, amplitude and peak width data.

14. The method according to claim 9, wherein generating real-time gas turbine combustion dynamics data comprises generating one or more of transverse mode frequency, amplitude and peak width data.

15. The method according to claim 9, wherein generating real-time gas turbine combustion dynamics data comprises generating one or more or radial mode frequency, amplitude and peak width data.

16. The method according to claim 9, wherein generating real-time gas turbine combustion dynamics data comprises generating one or more of axial mode harmonic overtone data, transverse mode harmonic overtone data and radial mode harmonic overtone data.

17. The method according to claim 9, wherein generating real-time gas turbine combustion dynamics data via one or more sensors comprises generating real-time gas turbine combustion dynamics data via a plurality of PCB sensors strategically located in axial and transverse directions on a combustor liner.

18. A method of determining gas turbine combustor health, the method comprising:
evaluating time domain combustion dynamics data acquired by one or more controllers, sensors and monitoring systems via a spectral and wavelet analysis data processing system (SWA) to identify gas turbine combustor high-amplitude signal characteristics and corresponding patterns and trends, and converting the combustion dynamics data to frequency domain data via the SWA;
evaluating the combustion dynamics data via an early detection data processing system (EDS) to identify low-amplitude patterns and trends having a potential to grow in the near future;
evaluating combustor operating condition data via a physics based prediction tools data processing system (PBPT) and predicting combustion dynamics therefrom, and comparing the predicted combustion dynamics against the real-time combustion dynamics data generated by the SWA and the EDS to identify features and amplitudes which cannot be explained by variations caused only by operating conditions;
storing and evaluating the data generated via the PBPT to identify patterns and trends, and comparing the patterns and trends to historical data stored in a historical data failure analysis database to generate current combustor condition data, and identifying and communicating the existence of any trend precedents to the PBPT such that the PBPT functions to identify potential causes of new trends and to provide remaining life assessment data based on the historical trending identified by the MHA;
comparing the life assessment data and the resultant trend in predicted dynamics to real-time data and trends via a real-time monitoring and analysis data processing module (RMAM) to identify differences that are communicated to a self-assessment and improvement data processing system (SAIM) such that the SAIM data processing system analyzes the differences and generates resultant combustor health, performance and life assessment data; and
communicating the resultant combustor health, performance and life assessment data via the RMAM to one or more corresponding gas turbine monitors and controllers.

19. The method according to claim 18, wherein converting the combustion dynamics data to frequency domain data via the SWA comprises generating real-time gas turbine combustion dynamics data comprising one or more of axial mode frequency, amplitude and peak width data, one or more of transverse mode frequency, amplitude and peak width data, one or more or radial mode frequency, amplitude and peak width data, and one or more of axial mode harmonic overtone data, transverse mode harmonic overtone data and radial mode harmonic overtone data.

20. The method according to claim 18, wherein acquiring real-time gas turbine combustion dynamics data via one or more controller, sensors and monitoring systems comprises generating real-time gas turbine combustion dynamics data via a plurality of PCB sensors strategically located in axial and transverse directions on a combustor liner.
